(19) United States
(12) Patent Application Publication
(10) Pub. No.: US 2021/0007570 A1
(43) Pub. Date: Jan. 14, 2021

(54) AUTONOMOUS TRAVELING TYPE VACUUM CLEANER AND CONTROL METHOD THEREOF

(71) Applicant: TOSHIBA LIFESTYLE PRODUCTS & SERVICES CORPORATION, Kawasaki-shi, Kanagawa (JP)

(72) Inventors: Toshihiro KAYAMA, Takatsu, Kawasaki (JP); Yuuji OHTSUKA, Fujisawa, Kanagawa (JP); Katsumi FUKUCHI, Hodogaya, Yokohama (JP); Yutaka UEDA, Hino, Tokyo (JP); Kenji YAMAGUCHI, Nakahara, Kawasaki (JP)

(73) Assignee: TOSHIBA LIFESTYLE PRODUCTS & SERVICES CORPORATION, Kawasaki-shi, Kanagawa (JP)

(21) Appl. No.: 16/978,876

(22) PCT Filed: Jan. 23, 2019
(86) PCT No.: PCT/JP2019/002085

§ 371 Date: Sep. 8, 2020

(30) Foreign Application Priority Data
Mar. 23, 2018 (JP) 2018-056542

(51) Int. Cl. A47L 9/28; B25J 11/00

(52) U.S. Cl. CPC A47L 9/2852; A47L 2201/04; A47L 9/2873; B25J 11/0085

(57) ABSTRACT

An autonomous traveling type vacuum cleaner capable of cleaning an area closely adjacent to an obstacle of a floor surface, and the control method therefor. A main body includes a front face part formed in a linear shape. A detector detects an obstacle in a traveling direction of the main body. A traveling part makes the front face part of the main body face the obstacle and makes the main body travel to the obstacle, on the basis of the result detected by the detector. A cleaning unit, which is disposed on a front portion of the main body, cleans a cleaning-object surface in the state where the traveling part has made the main body travel to the obstacle.

### TECHNICAL FIELD

Embodiments described herein relate generally to an autonomous traveling type vacuum cleaner configured to perform cleaning while traveling autonomously, and the control method therefor.

### BACKGROUND ART

Conventionally, a so-called autonomous traveling type vacuum cleaner (cleaning robot) has been known, which cleans a floor surface as a cleaning-object surface while autonomously traveling on the floor surface. Recently, more such vacuum cleaners are equipped with mapping technology, in order to perform cleaning by effectively utilizing a limited capacity of a battery serving as a power supply, and due to the improved ability of a sensor and a processor and reduced costs thereof. Such improvement and cost reduction in sensor technology further improves the functions of obstacle detection and obstacle avoidance in such an autonomous traveling type vacuum cleaner. Accordingly, a vacuum cleaner including a main body formed in a shape far from a conventional one, such as a shape with the radius thereof not varying during turning (a round shape or Reuleaux triangle) is also being made into a product.

There is a vacuum cleaner formed in, for example, a D shape, including a main body with a front face part formed in a linear shape and a dust suction head (including a floor brush and a suction port) which is similar to that of a hand-operated vacuum cleaner and is disposed on the forefront thereof. This vacuum cleaner, when detecting an obstacle, is controlled to turn at a position where the vacuum cleaner does not collide with the obstacle, and to travel along the obstacle in the vicinity of the obstacle. Therefore, it is difficult for the vacuum cleaner to clean an area closely adjacent to the obstacle of a floor surface.

### CITATION LIST

### Patent Literature

PTL 1: Japanese Translation of PCT International Application Publication No. 2017-503267

### SUMMARY OF INVENTION

### Technical Problem

The technical problem by the present invention is to provide an autonomous traveling type vacuum cleaner capable of cleaning an area closely adjacent to an obstacle of a cleaning-object surface, and a control method therefor.

### Solution to Problem

The autonomous traveling type vacuum cleaner in each of the embodiments has a main body, a detector, a traveling part, and a cleaning unit. The main body includes a front face part formed in a linear shape. The detector detects an obstacle in the traveling direction of the main body. The traveling part makes the front face part of the main body face the obstacle and makes the main body travel to the obstacle, on the basis of the result detected by the detector. The cleaning unit, which is disposed on a front portion of the main body, cleans a cleaning-object surface in the state where the traveling part has made the main body travel to the obstacle.

The control method for the autonomous traveling type vacuum cleaner in each of the embodiments is for the autonomous traveling type vacuum cleaner which has the main body with the front face part formed in a linear shape and which is capable of traveling autonomously. The control method for the autonomous traveling type vacuum cleaner includes a detection step of detecting an obstacle in the traveling direction of the main body, making the front face part of the main body face the obstacle and making the main body travel to the obstacle, on the basis of detection result, and cleaning a cleaning-object surface in the state where the main body has been made to travel to the obstacle.

### BRIEF DESCRIPTION OF DRAWINGS

FIG. 1 is a plan view of an autonomous traveling type vacuum cleaner of a first embodiment viewed from below.

FIG. 2 is an oblique view illustrating the above autonomous traveling type vacuum cleaner.

FIG. 3(a) is a block diagram illustrating one example of an internal configuration of the above autonomous traveling type vacuum cleaner; FIG. 3(b) is a block diagram partially illustrating another example of an internal configuration of the above autonomous traveling type vacuum cleaner; FIG. 3(c) is a block diagram partially illustrating further another example of an internal configuration of the above autonomous traveling type vacuum cleaner; and FIG. 3(d) is a block diagram partially illustrating further another example of an internal configuration of the above autonomous traveling type vacuum cleaner.

FIG. 4(a) is an explanatory drawing schematically illustrating one example of an operation of detecting an obstacle in the above autonomous traveling type vacuum cleaner; FIG. 4(b) is an explanatory drawing schematically illustrating another example of an operation of detecting an obstacle in the above autonomous traveling type vacuum cleaner; and FIG. 4(c) is an explanatory drawing schematically illustrating further another example of an operation of detecting an obstacle in the above autonomous traveling type vacuum cleaner.

FIG. 5(a) is an explanatory drawing schematically illustrating a method of determining a shape of an obstacle in the side of the main body of the above autonomous traveling type vacuum cleaner; FIG. 5(b) is an explanatory drawing schematically illustrating a determination method of the case where a shape of an obstacle in the side of the main body of the above autonomous traveling type vacuum cleaner is an convex curved shape; and FIG. 5(c) is an explanatory drawing schematically illustrating a determination method of the case where a shape of an obstacle in the side of the main body of the above autonomous traveling type vacuum cleaner is an concave curved shape.

FIG. 6(a) is an explanatory drawing schematically illustrating an operation of travel control of making the front face part of the main body of the above autonomous traveling type vacuum cleaner face an obstacle; FIG. 6(b) is an explanatory drawing schematically illustrating the operation following (a) in the travel control of making the front face part of the main body of the above autonomous traveling type vacuum cleaner face the obstacle; FIG. 6(c) is an explanatory drawing schematically illustrating the operation following (b) in the travel control of making the front face part of the main body of the above autonomous traveling type vacuum cleaner face the obstacle; and FIG. 6(d) is an explanatory drawing schematically illustrating the state where the front face part of the main body of the above autonomous traveling type vacuum cleaner is in close contact with the obstacle.

FIG. 7(a) is an explanatory drawing schematically illustrating one example operation in travel control of the above autonomous traveling type vacuum cleaner against an obstacle having a width less than a certain length; FIG. 7(b) is an explanatory drawing schematically illustrating an operation following (a) in the one example operation of the travel control of the above autonomous traveling type vacuum cleaner against the obstacle having the width less than the certain length; FIG. 7(c) is an explanatory drawing schematically illustrating an operation following (b) in the one example operation of the travel control of the above autonomous traveling type vacuum cleaner against the obstacle having the width less than the certain length; and FIG. 7(d) is an explanatory drawing schematically illustrating an operation following (c) in the one example operation of the travel control of the above autonomous traveling type vacuum cleaner against the obstacle having the width less than the certain length.

FIG. 8(a) is an explanatory drawing schematically illustrating one example operation of travel control of the case where a shape of an obstacle in the side of the main body of the above autonomous traveling type vacuum cleaner is a convex curved shape; FIG. 8(b) is an explanatory drawing schematically illustrating another example operation in the travel control of the case where the shape of the obstacle in the side of the main body of the above autonomous traveling type vacuum cleaner is a convex curved shape; FIG. 8(c) is an explanatory drawing schematically illustrating one example operation in travel control of the case where a shape of an obstacle in the side of the main body of the above autonomous traveling type vacuum cleaner is a concave curved shape; and FIG. 8(d) is an explanatory drawing schematically illustrating another example operation in the travel control of the case where the shape of the obstacle in the side of the main body of the above autonomous traveling type vacuum cleaner is a concave curved shape.

FIG. 9(a) is an explanatory drawing schematically illustrating one example operation of sideways-move control of an autonomous traveling type vacuum cleaner of a second embodiment; FIG. 9(b) is an explanatory drawing schematically illustrating an operation following (a) in the one example of the above sideways-move control; FIG. 9(c) is an explanatory drawing schematically illustrating an operation following (b) in the one example of the above sideways-move control; and FIG. 9(d) is an explanatory drawing schematically illustrating an operation following (c) in the one example of the above sideways-move control.

FIG. 10(a) is an explanatory drawing schematically illustrating another example operation of sideways-move control of the above autonomous traveling type vacuum cleaner; FIG. 10(b) is an explanatory drawing schematically illustrating an operation following (a) in another example of the above sideways-move control; FIG. 10(c) is an explanatory drawing schematically illustrating an operation following (b) in another example of the above sideways-move control; and FIG. 10(d) is an explanatory drawing schematically illustrating an operation following (c) in another example of the above sideways-move control.

FIG. 11(a) is an explanatory drawing schematically illustrating further another example operation of sideways-move control of the above autonomous traveling type vacuum cleaner; FIG. 11(b) is an explanatory drawing schematically illustrating an operation following (a) in the further another example of the above sideways-move control; and FIG. 11(c) is an explanatory drawing schematically illustrating an operation following (b) in the further another example of the above sideways-move control.

FIG. 12 is an explanatory drawing schematically illustrating an operation in sideways-move control of an autonomous traveling type vacuum cleaner of a third embodiment.

FIG. 13 is a flowchart indicating a control method for an autonomous traveling type vacuum cleaner of a fourth embodiment.

FIG. 14 is a flowchart indicating a control method for an autonomous traveling type vacuum cleaner of a fifth embodiment.

### DESCRIPTION OF EMBODIMENTS

### First Embodiment

The configuration of the first embodiment is described below by referring to the drawings.

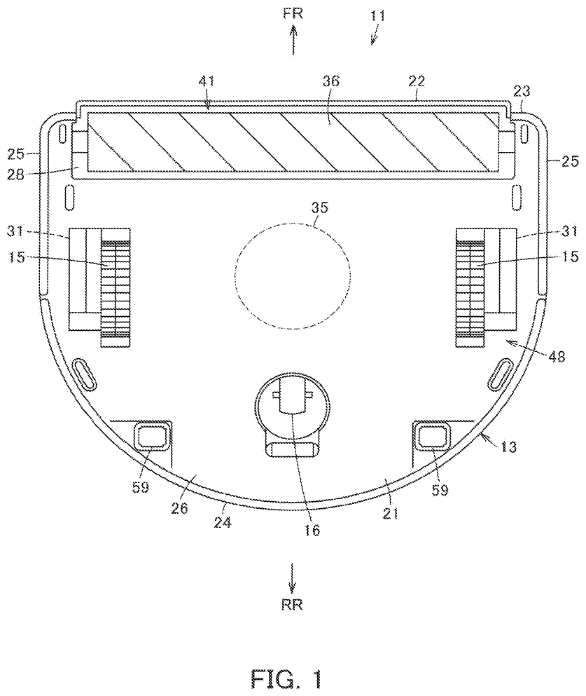

In FIG. 1 to FIG. 3, reference sign 11 denotes an autonomous traveling type vacuum cleaner. Hereinafter, the autonomous traveling type vacuum cleaner 11 is simply referred as a vacuum cleaner 11. The vacuum cleaner 11 cleans a floor surface which is a cleaning-object surface as a traveling surface, while autonomously traveling on the floor surface. In the present embodiment, the vacuum cleaner 11 is called as a robot cleaner or a cleaning robot. The vacuum cleaner 11 may be included in a vacuum cleaning apparatus serving as an autonomous traveler device, in combination with a charging device not shown as a station device serving as a base station for charging.

The vacuum cleaner 11 includes a main body 13. The vacuum cleaner 11 further includes travel driving means 14. The vacuum cleaner 11 further includes cleaning driving means 17. The vacuum cleaner 11 further includes control means 18 serving as a controller. The vacuum cleaner 11 includes detection means 19. The vacuum cleaner 11 may also include a battery for power supply serving as a power source part. It is noted that the vacuum cleaner 11 may further include a communication part configured to communicate with an external device, and an input part configured to accept external input from a user. The following description will be given on the basis that the direction extending along the traveling direction of the main body 13 is treated as the back-and-forth direction (directions of an arrow FR and an arrow RR shown in FIG. 1 and other drawings), while the left-and-right direction or the direction toward both sides intersecting or orthogonally crossing the back-and-forth direction is treated as the width direction or the lateral direction.

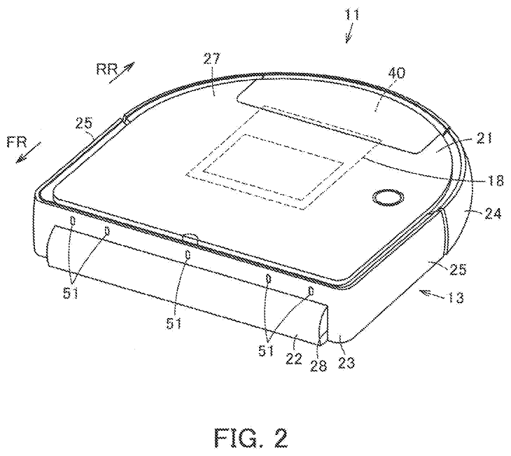

As shown in FIG. 1 and FIG. 2, in the present embodiment, the main body 13 includes a casing (casing body) 21 and a front cover 22. The main body 13 may further include a member such as a shock absorber included in an external appearance.

In the present embodiment, the casing 21 is formed in a substantially D shape in a plan view, that is, as viewed from above or from below. The casing 21 includes a front face part 23 formed in a linear shape extending along the width direction, and a rear face part 24 formed in a circular arc. Although the casing 21 in the present embodiment further includes side face parts 25 between the front face part 23 and the rear face part 24, these side face parts 25 are not essential components. The both sides of the rear face part 24 may be connected directly to the both sides of the front face part 23. It is noted that the shape of the casing 21 is not limited to the substantially D shape, as long as the casing 21 includes the front face part 23 formed in a linear shape extending along the width direction. The casing 21 further includes a bottom face part 26. The casing 21 further includes an upper face part 27. The casing 21 includes a suction port 28 which is a dust-collecting port.

The front face part 23 is included in the forefront of the main body 13. It is noted that the front face part 23 may have a protrusion, a concave, a convex or the like formed on the surface, as long as the front face part 23 is formed linearly along the width direction as a whole.

In the present embodiment, the rear face part 24 is formed in a convex shape projecting in the backward direction over the side face parts 25 of the main body 13. The rear face part 24 is formed in a semi-circular arc.

The side face parts 25 are formed so as to extend in the backward direction from the both side portions of the front face part 23, linearly along the back-and-forth direction. The front face part 23 is positioned between the front edge portions of the side face parts 25, and the rear face part 24 is positioned between the rear edge portions thereof.

The bottom face part 26 faces a floor surface. The bottom face part 26 may not necessarily be formed in a planar shape. The bottom face part 26 may have a concave or a convex.

In the present embodiment, the suction port 28 is formed on the bottom face part 26 facing a floor surface. The suction port 28 is positioned close to the front side of the main body 13. The suction port 28 is formed in a longitudinal shape long in the width direction, that is, a laterally long shape or a wide shape. The suction port 28 is formed so as to correspond to the width size of the casing 21. The suction port 28 in the present embodiment is disposed, for example, symmetrically with respect to the center line of the main body 13 in the width direction, but may be slightly displaced, not being disposed symmetrically. That is, although the center part of the suction port 28 in the width direction coincides with the center part of the main body 13 in the width direction in the present embodiment, they may be displaced from each other.

The front cover 22 is a separate member from the casing 21, and is attached to the front portion of the casing 21 so as to protrude in the forward direction from the front face part 23. The front cover 22, which is formed in a laterally long flap shape, covers the front portion of the suction port 28. The upper edge portion of the front cover 22 is rotatably supported to the casing 21, and the lower edge portion thereof is a free end rotatable in the back-and-forth direction to the casing 21. That is, the front cover 22 is a vacuum adjustment member which allows the lower edge portion to be rotated in the back-and-forth direction with respect to the suction port 28 so as to adjust vacuum in the suction port 28. The lower edge portion of the front cover 22 is biased forward in the rotating direction by biasing means such as a torsional spring not shown. That is, the front cover 22 is a shock absorber, allowing the lower edge portion to be rotated in the backward direction against the biasing force when contacting to a wall or the like, thereby relaxing the impact at the time of the contact between the main body 13 and a wall.

The travel driving means 14 is configured to drive the main body 13 to travel. The travel driving means 14 includes motors 31 serving as driving means configured to drive driving wheels 15.

As shown in FIG. 1, the vacuum cleaner 11 includes the driving wheels 15. The driving wheels 15 are configured to make the main body 13 autonomously travel on a floor surface in the advancing direction and the retreating direction. In an example, the driving wheels 15 are wheels movable in all directions. The driving wheels 15 are disposed on the bottom face part 26 of the main body 13. Although, in the present embodiment, the driving wheels 15 are disposed in a pair, for example, on the left and right sides of the main body 13 at positions behind the suction port 28, the arrangement is not limited thereto. The driving wheels 15 are independently driven by the motors 31. Each of the driving wheels 15 may be a driving device capable of moving the main body 13 in the lateral direction, for example, an omni-wheel or a mecanum wheel. It is noted that a crawler or the like is available as a traveling wheel serving as a driven part, instead of these driving wheels 15.

The vacuum cleaner 11 may include a swing wheel 16. The swing wheel 16 is configured to support the main body 13 on a floor surface, together with the driving wheels 15. The swing wheel 16 is disposed on the bottom face part 26 of the main body 13 facing a floor surface. The swing wheel 16, which is a driven wheel, is disposed freely rotatably on the bottom of the main body 13 so as to be in contact with a floor surface and be turnable as a unit in parallel or in substantially parallel with the floor surface. Although, in the present embodiment, the swing wheel 16 is positioned behind the driving wheels 15 and is disposed at the center portion in the width direction of the main body 13, the arrangement is not limited thereto.

The cleaning driving means 17 is configured to remove dust and dirt from a floor surface. In an example, the cleaning driving means 17 has the function of collecting and catching dust and dirt from a floor surface through the suction port 28, and/or the function of wiping a wall surface. In the present embodiment, the cleaning driving means 17 includes an electric blower 35 configured to suck and discharge air. The cleaning driving means 17 further includes a brush motor serving as rotation driving means configured to rotationally drive a rotary brush 36 serving as a rotary cleaner rotatably attached to the suction port 28 disposed on the front portion of the main body 13.

The electric blower 35 is configured to suck dust and dirt together with air into a dust-collecting unit 40 by applying a negative pressure through the suction port 28 to a floor surface. The electric blower 35 is accommodated in the main body 13, and the suction side thereof communicates with the suction port 28 via the dust-collecting unit 40.

The rotary brush 36 is configured to scrape up or scrape out dust and dirt from a floor surface. The shaft direction of the rotary brush 36 is along the longitudinal direction of the suction port 28. In other words, the rotary brush 36 has a shaft disposed along the direction in parallel or substantially parallel with a floor surface, and is disposed so as to be rotated in the up-and-down direction. The rotary brush 36 and the suction port 28 are included in cleaning means 41 of the present embodiment. In the present embodiment, the cleaning means 41 is configured to remove dust and dirt from a floor surface facing the forefront bottom of the main body 13.

In an example, the dust-collecting unit 40 is detachably attached to the main body 13. In the present embodiment, the dust-collecting unit 40 is positioned at, for example, the rear portion of the main body 13.

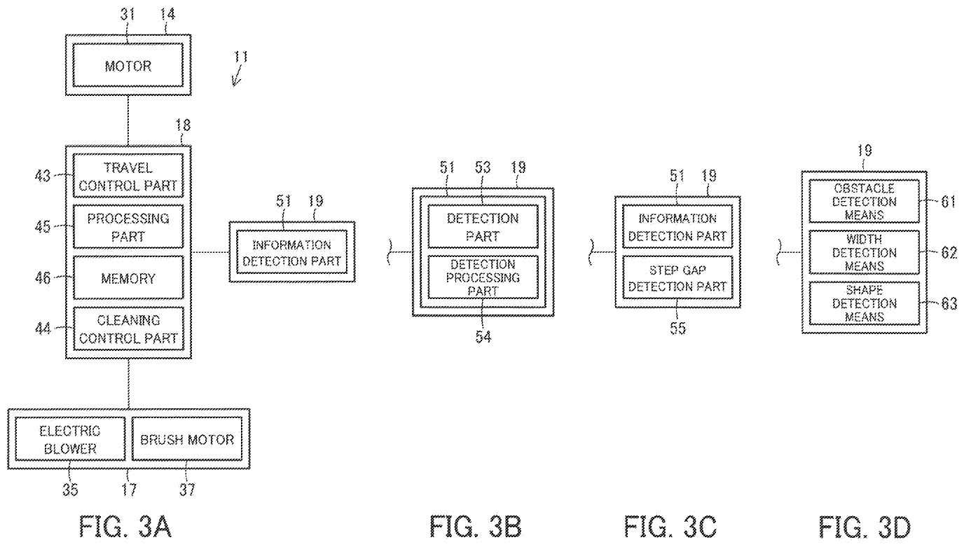

As in the examples shown in FIG. 3(a) to FIG. 3(c), the control means 18 is a microcomputer including a control means main body such as a CPU, a ROM and a RAM, as an example. The control means 18 is electrically connected to the travel driving means 14, the cleaning driving means 17, the detection means 19 and the like. More specifically, the control means 18 includes a travel control part 43 serving as travel control means. The control means 18 further includes a cleaning control part 44 serving as cleaning control means. The control means 18 may further include a processing part 45 having the functions of map creation means and self-position estimation means. The control means 18 further includes a memory 46 serving as storage means. Since the control means 18 is electrically connected to a battery, the control means 18 may include a charging control part configured to control battery charging.

The travel control part 43 controls the travel driving means 14. Specifically, the travel control part 43 is electrically connected to the motors 31, and controls the driving of the diving wheels 15 by controlling the motors 31. In an example, the travel control part 43 controls the motors 31 so as to rotate the driving wheels 15 made in a pair by the same number of times of rotation or at the same rotational speed in the same direction, thereby enabling to make the main body 13 travel straight in the rotation direction, that is, to make the main body 13 advance or retreat. The travel control part 43 controls the motors 31 so as to rotate the driving wheels 15 made in a pair in opposing directions, thereby enabling to make the main body 13 perform spin turn around the center point of the driving wheels 15 made in a pair. Hereinafter, in the present embodiment, in the case where the main body 13 turns simply, the main body 13 performs such spin turn. Moreover, the travel control part 43 controls the motors 31 so as to rotate one of the driving wheels 15 by a larger number of times of rotation or at a higher rotational speed than the number of times of rotation or the rotational speed of the other of the driving wheels 15, thereby enabling to make the main body 13 travel while curving to the right or left. Hereinafter, the operation is called a round turn. In this case, the other of the driving wheels 15 may be stopped, as an example. In combination with these operations, the main body 13 is able to be made to travel freely on a floor surface. Accordingly, the travel control part 43, the travel driving means 14 and the driving wheels 15 are included in travel means 48 configured to make the main body 13 travel.

The cleaning control part 44 is configured to control the cleaning driving means 17. In the present embodiment, the cleaning control part 44 controls the electric blower 35 and the brush motor 37.

The processing part 45 recognizes the arrangement of an obstacle, a step gap or the like detected by the detection means 19, creates map data of a cleaning-object area or the traveling area where the main body 13 is able to travel, and estimates a self-position. A known simultaneous localization and mapping (SLAM) technology or the like is available for creating map information and estimating a self-position, and thus the details thereof will be omitted. It is noted that the processing part 45 is not an essential component in the present embodiment.

A nonvolatile memory is used as the memory 46, for example, a flash memory. The memory 46 stores various types of data to be referred by the travel control part 43, the cleaning control part 44, the processing part 45 or the like. In an example, the memory 46 may store the map data created by the processing part 45. In the case where the vacuum cleaner 11 includes dust-and-dirt amount detection means, the memory 46 may store the dust-and-dirt amount map data in which the dust-and-dirt amounts detected at respective positions by the dust-and-dirt amount detection means are reflected, that is, a dust map.

The detection means 19 detects information on objects in the traveling direction of the main body 13. In the present embodiment, the information on objects relates to a distance between the front face part 23 of the main body 13 and an object, a width of an object, a shape of an object, and the like. The objects are obstacles such as a wall, a pillar, and a step gap. As shown in FIG. 3(a), the detection means 19 in the present embodiment is an information detection part 51.

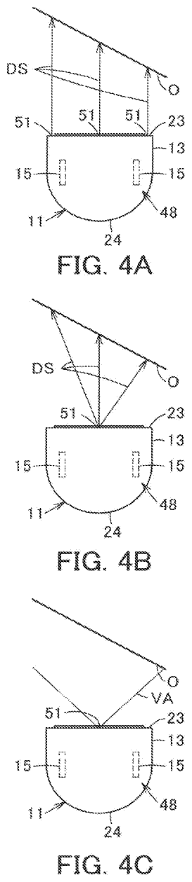

The information detection part 51 is obstacle detection means configured to detect an obstacle such as a wall or a pillar existing in the front or a step gap existing below in the traveling direction of the main body 13. The information detection part 51 may be, for example, a contact type or a noncontact type. In the description of the present embodiment, a noncontact type is used as the information detection part 51. Examples used as the information detection part 51 include a sensor, such as an infrared sensor or an ultrasonic sensor, configured to detect a distance between the main body 13 and an obstacle, a width of an obstacle and a shape of an obstacle by utilizing a detection signal, image capturing means configured to capture an image by use of a camera or a plurality of cameras, extract feature points or brightness of pixels from the image, and acquire various types of information such as on an obstacle, a step gap and a type of floor surface on the basis of the extracted information, and the combination of these. Examples of the information to be detected by the information detection part 51 include a distance and a relative coordinate between the front face part 23 of the main body 13 and an object. The information detection part 51 is preferably capable of detecting such information of a plurality of positions in front of the main body 13. Therefore, in the case where, for example, an infrared sensor or an ultrasonic sensor is used as the information detection part 51, the information detection part 51 is preferably capable of outputting a detection signal from a plurality of positions to an object in front of the main body 13, or outputting a detection signal to a plurality of directions. In the present embodiment, the forward of the main body 13 means the direction farther front than the front face part 23 on the basis of the front face part 23. In an example, as shown in FIG. 4(a), the information detection part 51 may be disposed at a plurality of positions different in the width direction of the main body 13, so as to output detection signals DS from the respective positions to the front direction perpendicular or substantially perpendicular to the front face part 23. In this case, the information detection parts 51 are preferably disposed respectively on the both side portions in the width direction, the center portion and the like of the main body 13. On the other hand, one unit of the information detection part 51 maybe disposed, as long as the information detection part 51 is capable of detecting an obstacle existing in front of the main body 13. In an example, as shown in FIG. 4(b), the information detection part 51 may be disposed so as to output the detection signals DS in various directions in the width direction by turning to the right/left of the main body 13, rotating or moving. In this case, the information detection part 51 is preferably disposed on the center portion of the main body 13, or the like. In another case where a camera is used as the information detection part 51 as shown in FIG. 4(c), a camera having a vertical angle VA allowing to capture an image at least in the range corresponding to the width size of the main body 13 is preferably used. The information detection part 51 is preferably disposed on the front face part 23, or alternatively may be disposed at, for example, the position with its coordinate previously known based on the front face part 23, or at a position in a certain positional relation with the position of the front face part 23. Alternatively, the information detection part 51 may be disposed on, for example, the upper portion of the main body 13, as long as the disposed information detection part 51 is capable of measuring a distance to an object in front of the main body 13.

The information detection part 51 detects a distance between the main body 13 and an object existing in the advancing direction of the main body 13, and determines whether or not the object is an obstacle on the basis of the detected distance. The information detection part 51 compares the distance between the main body 13 and the object existing in the advancing direction of the main body 13 with a first threshold value previously determined. In the case of detecting that the distance between the main body 13 and the object is equal to or less than the first threshold value previously determined, the information detection part 51 determines that the object is an obstacle. The first threshold value is a numerical value indicating the distance between the main body 13 and the object existing in the advancing direction of the main body 13. In the case where a plurality of information detection parts 51 are provided and where the distance between the main body 13 and the object detected by the detection signals output in any one of the directions is equal to or less than the first threshold value previously determined, the object is determined as an obstacle. It is noted that although the information detection parts 51 in the example shown in FIG. 3(a) are configured to output a detection signal to the direction perpendicular or substantially perpendicular to the front face part 23, in other words, in parallel or substantially parallel to the back-and-forth direction of traveling of the main body 13, the detection signal may be output to a direction inclined relative to the traveling direction of the main body 13. In this case, the first threshold value may be set, allowing that an object is determined as an obstacle on the basis of the inclined angle of the detection signal to the back-and-forth direction of traveling of the main body 13. That is, as the inclined angle of the detection signal to the back-and-forth direction of traveling of the main body 13 is larger, a larger value may be set as the first threshold value.

As in the example shown in FIG. 3(b), the information detection part 51 may be configured with a detection part 53 and a detection processing part 54. The detection part 53 detects an object existing in the traveling direction of the main body 13. The detection processing part 54 processes the information acquired by the detection part 53 to determine whether or not the object is an obstacle. The detection processing part 54 acquires the result detected by the detection part 53, and is able to output the result to the travel control part 43 and the cleaning control part 44. In an example, in the case where the detection part 53 detects a distance and where the distance is equal to or less than the first threshold value previously determined, the detection processing part 54 determines that the object is an obstacle. In the case where the vacuum cleaner 11 includes a plurality of the detection parts 53 and where the distance to an object detected by any one of the detection parts 53 is equal to or less than the first threshold value previously determined, the detection processing part 54 determines that the object is an obstacle. Alternatively, in the case where the detection part 53 in the vacuum cleaner 11 outputs detection signals to a plurality of directions and where the distance to an object detected by the detection signal output to anyone of the directions is equal to or less than the first threshold value previously determined, the detection processing part 54 determines that the object is an obstacle. In determining of an obstacle, the first threshold value for determining that an object is an obstacle may be changed on the basis of the output angle of the detection signal to the back-and-forth direction of traveling of the main body 13. That is, as the output angle of the detection signal is larger, a larger value may be set as the first threshold value.

The information detection part 51 may further have the function of width detection means. The width detection means detects whether or not the width of the obstacle existing in the traveling direction of the main body 13 is equal to or more than a second threshold value previously determined in the lateral direction, and determines the type of the obstacle on the basis of the detection result. The second threshold value is a numerical value indicating a width of an obstacle existing in the traveling direction of the main body 13. In the case of detecting that a width of an obstacle existing in the traveling direction of the main body 13 is equal to or more than the second threshold value previously determined in the lateral direction, the width detection means determines that the obstacle is a wall-like obstacle. In the case of detecting that a width of an obstacle existing in the traveling direction of the main body 13 is less than the second threshold value previously determined in the lateral direction, the width detection means determines that the obstacle is a bar-like obstacle. In the case where a plurality of units of the width detection means are provided and where the width of the obstacle detected by the detection signals output to any one of the directions is equal to or more than the second threshold value previously determined, the obstacle is determined as a wall-like obstacle.

In the case where the information detection part 51 also has the function of the width detection means, the information detection part 51 may be configured with the detection part 53 and the detection processing part 54, as shown in FIG. 3(b). The detection part 53 detects a width of an obstacle existing in the advancing direction of the main body 13. The detection processing part 54 compares the width of the obstacle detected by the detection part 53 with the second threshold value previously determined, and determines whether or not the obstacle is a wall-like obstacle. In an example, in the case where the main body 13 faces an obstacle, the detection parts 53 disposed at a plurality of positions in the width direction detect the distance to the object, whereby the width detection means may determine whether or not the width of the object is equal to or more than the second threshold value previously determined in the lateral direction. Alternatively, the detection part 53 may detect a distance between the main body 13 and the object by outputting the detection signals while the travel means 48 makes the main body 13 turn, and the width detection means may determine the width of the object on the basis of the distance. In the present embodiment, the information detection part 51 is configured to detect an obstacle with its lateral width being equal to or more than the half of or equal to or more than the lateral width of the main body 13. Accordingly, the information detection part 51 is preferably capable of detecting information of a plurality of positions in the width direction set by intervals equal to or less than the second threshold value described above, specifically in the present embodiment, by intervals at most equal to the half of the width size of the main body 13.

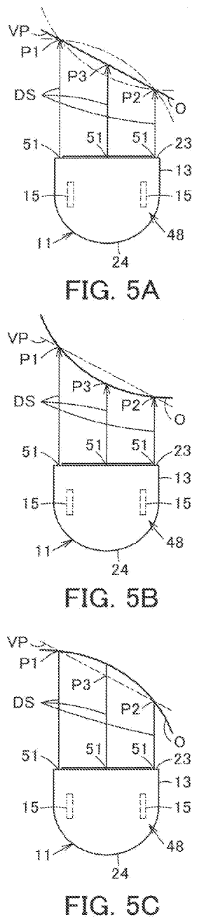

The information detection part 51 is the shape detection means configured to detect the shape of the object determined as an obstacle. Specifically, as shown in FIG. 5, the shape detection means is configured to determine whether the shape of the obstacle in the side of the main body 13 is a planar shape or a curved shape. In an example, the shape detection means may determine whether three points or more in the width direction of the obstacle are on the same plane or substantially on the same plane, thereby determining whether the shape of the obstacle in the side of the main body 13 is a planar shape or a curved shape. For example, in the vacuum cleaner 11 including three units or more of the shape detection means, a shape of an obstacle O in the side of the main body 13 is able to be determined as a planar shape as indicated by the solid line shown in FIG. 5(a), in the case where a virtual vertical plane VP including at least two points P1, P2 obtained on the basis of the distances to the obstacle O detected by at least two units of the shape detection means includes a remaining point P3 of the obstacle O obtained on the basis of the distance detected by a remaining unit of the shape detection means, or in the case where the distance from a remaining unit of the shape detection means to the virtual vertical plane VP is equal to or substantially equal to the distance to the point P3 of the obstacle O actually detected by the shape detection means. In the case where the virtual vertical plane VP does not include the remaining point P3, or in the case where the distance from a remaining unit of the shape detection means to the virtual vertical plane VP is not equal to the distance to the point P3 of the obstacle O actually detected by the shape detection means, the shape of the obstacle O is able to be determined as a curved shape as indicated by one of the two-dot chain lines shown in FIG. 5(a). In the case of, by using such a method, detecting that the shape of the obstacle in the side of the main body 13 is a curved shape, the shape detection means may determine whether the curved shape is a convex curved shape or a concave curved shape. That is, the information detection part 51 is capable of determining whether the shape of the obstacle O in the side of the main body 13 is a convex curved shape or a concave curved shape, on the basis of a small/large relation between the distance to the virtual vertical plane VP including at least the two points P1, P2 obtained on the basis of the distances to the obstacle O detected by at least two units of the shape detection means in three units or more of the shape detection means, from a remaining unit of the shape detection means, and the distance to the point P3 of the obstacle O actually detected by the shape detection means. For example, in the case where the distance to the virtual vertical plane VP from the shape detection means configured to detect a distance to the point P3 existing between the points P1, P2 of the obstacle O is shorter than the distance to the point P3 actually detected by the shape detection means, the shape of the obstacle O in the side of the main body 13 is able to be determined as the convex carved shape projecting toward the main body 13, as shown in FIG. 5(b). Alternatively, in the case where the distance is larger, the shape of the obstacle O in the side of the main body 13 is able to be determined as the concave curved shape, as shown in FIG. 5(c).

It is noted that the small/large relation for determining the curved shape of the obstacle in the side of the main body 13, between the distance from the shape detection means to the virtual vertical plane VP and the distance to the point actually detected by the shape detection means differs depending on the position of the point on the obstacle subjected to the distance detection. In an example, in FIG. 5(b) and FIG. 5(c), in the case where the virtual vertical plane VP is set on the basis of the points P1, P3, and where the distance to the point P2 actually detected by the shape detection means is larger than the distance from the shape detection means to the virtual vertical plane VP, the shape of the obstacle O in the side of the main body 13 is able to be determined as the convex curved shape projecting toward the main body 13. In the case where the distance is smaller, the shape of the obstacle O in the side of the main body 13 is able to be determined as a concave curved shape. Accordingly, the small/large relation described above is preferably set for each of a plurality of points in the side of the main body 13 of the obstacle subjected to the detection. For example, also in the case where the shape detection means in the vacuum cleaner 11 outputs the detection signals to a plurality of directions, the shape detection means detects the distances to three points or more in the width direction of the obstacle, thereby enabling to likewise determine the shape of the obstacle in the side of the main body 13.

In the case where the information detection part 51 also has the function of the shape detection means, the information detection part 51 may be configured with the detection part 53 and the detection processing part 54, as in the example shown in FIG. 3(b).

It is noted that, in any of the case where the information detection part 51 detects a distance between the main body 13 and an obstacle, the case where the information detection part 51 detects a width of an obstacle, and the case where the information detection part 51 detects a shape of an obstacle in the side of the main body 13, the travel means 48 may make the main body 13 of the vacuum cleaner 11 stop temporarily, or may make the main body 13 move at a slower speed than that at the time of cleaning.

In the case of using image capturing means as the information detection part 51, the information detection part 51 is capable of further functioning as a step gap detection part 55 configured to detect a travel obstacle existing on a floor surface below the main body 13. As in the example shown in FIG. 3(c), the detection means 19 may include the step gap detection part 55 as a separate unit from the information detection part 51, in order to more reliably detect a travel obstacle existing on a floor surface.

The step gap detection part 55 is configured to detect information on objects existing on a floor surface. In an example, the step gap detection part 55 is capable of detecting a concave step gap and/or a convex step gap on a floor surface. In the case of the detection means 19 including the step gap detection part 55, a noncontact type is used, likewise as, for example, the information detection part 51 shown in FIG. 2. The step gap detection parts 55 are preferably disposed in front and rear respectively of the driving wheels 15 on the bottom face part 26 of the main body 13. The step gap detection parts 55 are preferably disposed in a pair in the right and left, in order to more reliably detect a travel obstacle in front of the main body 13. In the present embodiment, the step gap detection parts 55 are disposed respectively at the positions of the both sides of the suction port 28 in the vicinity of the forefront of the main body 13, and at the positions of the both sides in rear of the suction port 28 and in front of the driving wheels 15 and the positions of the both sides in rear of the driving wheels 15 and in front of the swing wheel 16, respectively, in the vicinities of the outer edge portions of the main body 13. In the present embodiment, in the case of detecting that a distance between the bottom of the main body 13 and a floor surface is equal to or less than a certain distance previously determined, the step gap detection part 55 determines that there is the convex step gap which the main body 13 is not able to get over. In the case of detecting that a distance between the bottom of the main body 13 and a floor surface is equal to or more than a certain distance previously determined, the step gap detection part 55 determines that there is a concave step gap which the main body 13 is not able to go over, for example, a down staircase. As described above, the step gap detection part 55 is a travel obstacle detection part serving as travel obstacle detection means configured to detect a travel obstacle existing on a floor surface below the main body 13.

As shown in FIG. 3(d), the detection means 19 may be configured with obstacle detection means 61, width detection means 62 and shape detection means 63, disposed individually. The obstacle detection means 61, the width detection means 62 and the shape detection means 63 respectively detect and determine information relative to an object. Even such a configuration enables to exhibit the same effects as those described above. Alternatively, the functions of any two of the obstacle detection means 61, the width detection means 62 and the shape detection means 63 may be configured in one configuration, and the remaining one function may be configured separately.

The detection means 19 may include dust-and-dirt amount detection means configured to detect the dust-and-dirt amount existing on a floor surface, to be caught and collected in the dust-collecting unit 40 through the suction port 28. The detection means 19 may further include, for example, floor surface detection means configured to detect a type of a floor surface.

A battery is configured to supply power to the cleaning driving means 17, the control means 18, the detection means 19 and the like. In the present embodiment, for example, a rechargeable secondary battery is used as the battery. Therefore, in the present embodiment, for example, charging terminals 59 for charging the battery are disposed on the main body 13. The charging terminals 59 are electrically connected to the terminals for charging disposed on a charging device, for example, when the vacuum cleaner 11 returns to the charging device, whereby the battery is allowed to be charged by the power supplied by the charging device. In an example, the charging terminals 59 are disposed in a pair in the right and left of the bottom face part 26 of the main body 13.

The operation of the above first embodiment is described next.

The outline from the start to the end of the cleaning to be performed by the vacuum cleaner 11 is described first. After the vacuum cleaner 11 undocks from, for example, the charging device and starts cleaning from a certain position, the cleaning means 41 cleans a floor surface while the travel means 48 makes the vacuum cleaner 11 autonomously travel in a traveling area. After traveling in the entire traveling area, the vacuum cleaner 11 returns to the charging device and is connected to the charging device, and thereafter finishes the cleaning. After finishing the cleaning, the charging of the battery is started at certain timing.

In the vacuum cleaner 11 when performing the autonomous traveling described above, the travel means 48 makes the front face part 23 of the main body 13 face an obstacle and makes the main body 13 travel to the obstacle, on the basis of the result detected by the detection means 19.

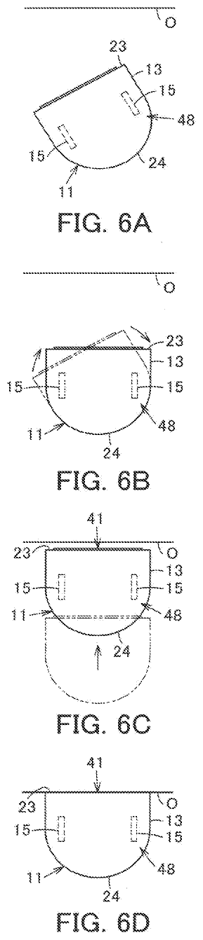

In the present embodiment, as shown in FIG. 6(a) to FIG. 6(c), when the detection means 19 detects an obstacle O, the vacuum cleaner 11 determines whether or not the front face part 23 of the main body 13 faces the obstacle O, on the basis of the distance between the front face part 23 of the main body 13 and the obstacle O. In the case where the front face part 23 of the main body 13 does not face the obstacle O, the travel means 48 makes the main body 13 turn so that the front face part 23 of the main body 13 faces toward the obstacle O, thereby making the front face part 23 of the main body 13 face the obstacle O. Thereafter, the travel means 48 makes the main body 13 travel to the obstacle O, and the cleaning means 41 cleans a floor surface in front of the main body 13 having been made to travel to the obstacle O. That is, in the vacuum cleaner 11, the travel means 48 makes the front face part 23 of the main body 13 face the obstacle O and makes the main body 13 travel to the obstacle O, on the basis of the result detected by the detection means 19, and the cleaning means 41 disposed on the front portion of the main body 13 cleans a floor surface in front of the main body 13 in the state where the front face part 23 of the main body 13 faces the obstacle. As a result, the cleaning means 41 is capable of cleaning an area closely adjacent to the obstacle of a floor surface, by utilizing the shape of the main body 13 including the front face part 23 formed in a linear shape and including the cleaning means 41 disposed on the front portion thereof.

In this case, the travel means 48 may make the main body 13 travel to the obstacle O, or may make the main body 13 travel so that the front face part 23 is brought into close contact with the obstacle O. As shown in FIG. 6(d), in the vacuum cleaner 11, the cleaning means 41 may clean a floor surface in front of the main body 13, in the state where the front face part 23 of the main body 13 having traveled to the obstacle O faces the obstacle O while being inclose contact therewith. The state of the front face part 23 in close contact with the obstacle enables to clean an area closely adjacent to the obstacle of a floor surface, enables to improve the cleaning efficiency, and enables to suck dust and dirt reliably. In the present embodiment, since the front cover 22 projects forward farther than the front face part 23, the front cover 22 is first brought into contact with an obstacle, and is rotated to the backward direction against a biasing force, thereby enabling to relax the impact at the time of the contact. At this time, the front cover 22 is pushed to the backward direction by the reaction force by the contact, and the opening degree of the suction port 28 is reduced, thereby increasing the degree of vacuum in the suction port 28, resulting in enabling to more reliably suck dust and dirt from a floor surface through the suction port 28.

In the vacuum cleaner 11, the main body 13 having been made to travel to the obstacle may be stopped temporarily, in the state where the front face part 23 of the main body 13 faces the obstacle, and the cleaning means 41 may clean a floor surface in front of the main body 13 during the stop. As a result, an area closely adjacent to the obstacle of a floor surface is able to be intensively cleaned in the stop state, and thus the floor surface is able to be cleaned more reliably.

In this case, in the vacuum cleaner 11, the travel control may be changed depending on the size in the width direction of the obstacle. That is, in the case where the width of the obstacle detected by the detection means 19 is equal to or more than the second threshold value previously determined in the lateral direction, the main body 13 may be made to travel to the obstacle.

Specifically, in the case where the obstacle is assumed to have a shape suitable for the cleaning performed by the front portion of the main body 13 including the front face part 23 formed in a linear shape, and where the information detection part 51 detects that the detected width of the obstacle is equal to or more than the second threshold value previously determined in the lateral direction, the travel means 48 makes the main body 13 travel to the obstacle and the cleaning means 41 perform cleaning, thereby enabling to clean an area of a floor surface closely adjacent to the wall-like obstacle wide in the lateral direction. In this case, the travel means 48 makes the main body 13 stop temporarily, and the cleaning means 41 performs cleaning, thereby enabling to intensively clean an area closely adjacent to the obstacle of a floor surface in the stop state, resulting in enabling to more reliably clean a floor surface.

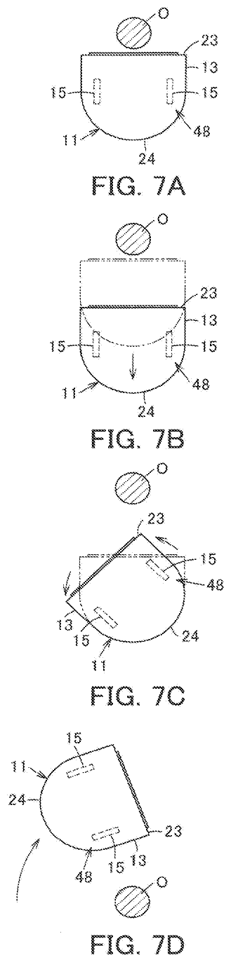

On the other hand, in the case where the detection means 19 does not detect that the detected width of the obstacle is equal to or more than the second threshold value previously determined in the lateral direction, that is, in the case where the width of the obstacle is not equal to or more than a certain size in the width direction, the obstacle is assumed to have a shape not suitable for the cleaning performed by the front portion of the main body 13 having the front face part 23 formed in a linear shape, for example, by the linearly formed front face part 23. Accordingly, the obstacle is assumed to be, for example, a bar-like pillar or a leg of a chair. In this case, if, as described above, the main body 13 is made to stop temporarily and the cleaning means 41 performs cleaning in the state where the front face part 23 of the main body 13 is closely adjacent to or in close contact with the obstacle, the power to be used normally for cleaning may be wasted. Therefore, in this case, as shown in FIG. 7(a) to FIG. 7(d), the travel means 48 may make the main body 13 having been made to travel to the obstacle O, for example, retreat temporarily, turn or perform round turn, so as to avoid the obstacle O. As a result, the optimum travel control is able to be set according to the shape of the obstacle.

In the case where the obstacle has a wide and planar shape in the side of the main body 13, an area closely adjacent to the obstacle of a floor surface is able to be cleaned most efficiently. On the other hand, in the case where the obstacle has a wide and curved shape in the side of the main body 13, the travel means 48 changes the travel control according to whether the shape of the obstacle in the side of the main body 13 is a planar shape or a curved shape, thereby enabling to efficiently clean an area of a floor surface which is closely adjacent to the obstacle but where the front face part 23 is away from the obstacle.

Accordingly, in the case where the detection means 19 detects that the detected width of the obstacle is equal to or more than the second threshold value previously determined in the lateral direction and that the shape of the obstacle in the side of the main body 13 is a planar shape, the travel means 48 may make the main body 13 travel to the obstacle, while in the case where the detection means 19 detects that the detected width of the obstacle is equal to or more than the second threshold value previously determined in the lateral direction and that the shape of the obstacle in the side of the main body 13 is a curved shape, the travel means 48 may make the main body 13 having been made to travel to the obstacle travel so that the front face part 23 of the main body 13 moves along the shape of the obstacle in the side of the main body 13.

Moreover, the distances from the obstacle to the both side portions in the width direction and to the center portion of the front face part 23 of the main body 13 vary, depending on whether the shape of the obstacle in the side of the main body 13 is in a convex curved shape or a concave curved shape. Therefore, the vacuum cleaner 11 more preferably changes the travel control according to the curved shape of the obstacle in the side of the main body 13.

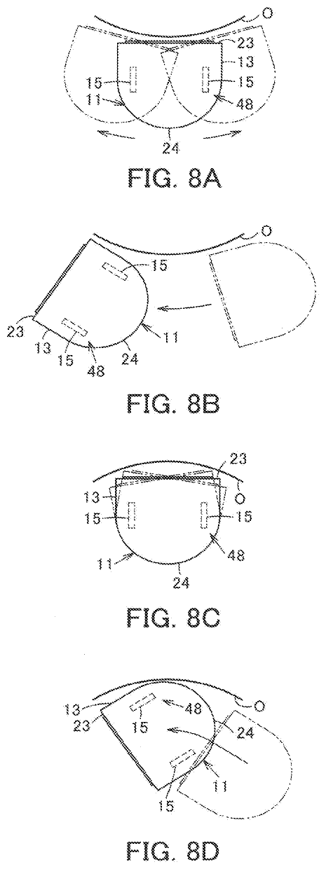

In the case where the obstacle O detected by the detection means 19 has a convex curved shape in the side of the main body 13, the travel means 48 may make, as shown in FIG. 8(a), the main body 13 travel in a curve, that is, perform round turn so that the front face part 23 of the main body 13 moves along the shape of the obstacle O in the side of the main body 13, or alternatively may make, as shown in FIG. 8(b), the main body 13 travel so that the side portion of the main body 13 moves along the shape of the obstacle O in the side of the main body 13. In the case where the obstacle O detected by the detection means 19 has a concave curved shape in the side of the main body 13, the travel means 48 may make, as shown in FIG. 8(c), the main body 13 turn so that the front face part 23 of the main body 13 moves along the shape of the obstacle O in the side of the main body 13, or alternatively may make, as shown in FIG. 8(d), the main body 13 travel so that the side portion of the main body 13 moves along the shape of the obstacle O in the side of the main body 13.

As a result, such methods enable to locate the front portion of the main body 13 where the suction port 28 is disposed, in an area closely adjacent to the obstacle of a floor surface, on the basis of the shape of the obstacle in the side of the main body 13, thereby enabling to more uniformly clean an area closely adjacent to the obstacle of a floor surface.

As described above, in any of the case of detecting a distance between the main body 13 and an obstacle, the case of detecting a size of a width of an obstacle, and the case of detecting a shape of an obstacle in the side of the main body 13, the configuration with a plurality of units of the detection means 19 allows to concurrently measure information relating to a plurality of points, thereby enabling to perform detection and determination in a short time. On the other hand, by use of the configuration with one unit of the detection means 19 configured to detect information relating to a plurality of directions, the configuration becomes simpler.

It is noted that, for example, in the case where the memory 46 stores the map data of a traveling area created by the processing part 45 at the time of previous cleaning, the travel control part 43 may set a traveling route along the stored map data. In this case, since the same travel control and the same cleaning control as those at the time of previous cleaning are assumed to be set normally, the control means 18 normally controls the traveling and the cleaning similarly, by referring to the previous control, whereby the processing load on the control means 18 is reduced and the cleaning time is able to be shortened, as compared with the case where the traveling control and the cleaning control are performed each time. In this case, the processing part 45 may update the map data when required, on the basis of the detection of the obstacle by the information detection part 51 during when the main body 13 is traveling autonomously.

In the case where the detection means 19 has the function of the obstacle detection means configured to detect an obstacle in front of the main body 13, the function of the width detection means configured to detect and determine a width of an obstacle, and the function of the shape detection means configured to detect and determine a shape of an obstacle, the configuration of the vacuum cleaner 11 becomes simpler and the production cost thereof is able to be reduced, and further the processing load on the control means 18 is able to be reduced, as compared with the configuration with these functions provided individually.

### Second Embodiment

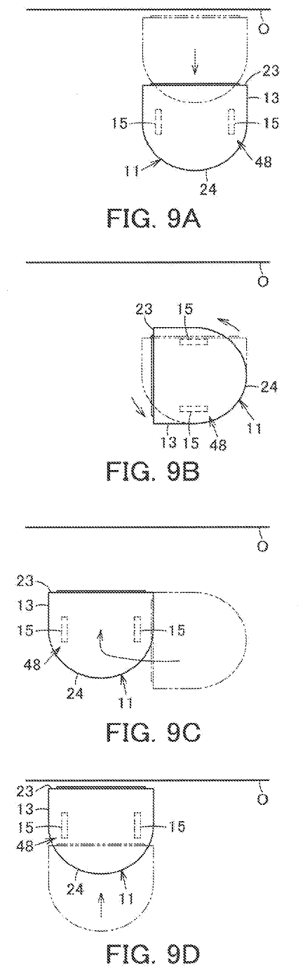

The second embodiment is described next by referring to FIG. 9 to FIG. 11. It is noted that the same configurations and actions as those of the first embodiment described above are denoted by the same reference signs, and the descriptions thereof are omitted.

In the second embodiment, when traveling toward an obstacle and cleaning an area closely adjacent to the obstacle of a floor surface, the vacuum cleaner 11 moves sideways in the lateral direction along the obstacle in the case where the width of the obstacle is equal to or more than the second threshold value previously determined in the lateral direction.

Specifically, the travel means 48 performs sideways-move control, that is, N-shaped travel control of making the main body 13 having been made to travel to the obstacle repeat the operation of temporarily retreating from the obstacle, moving sideways in the width direction, and traveling to the obstacle.

In this case, as in one example shown in FIG. 9(a) to FIG. 9(d), the travel means 48 may repeat the travel control of making the main body 13 retreat straight from the obstacle O, turn left, perform round turn to the right, and travel (advance) toward the obstacle O.

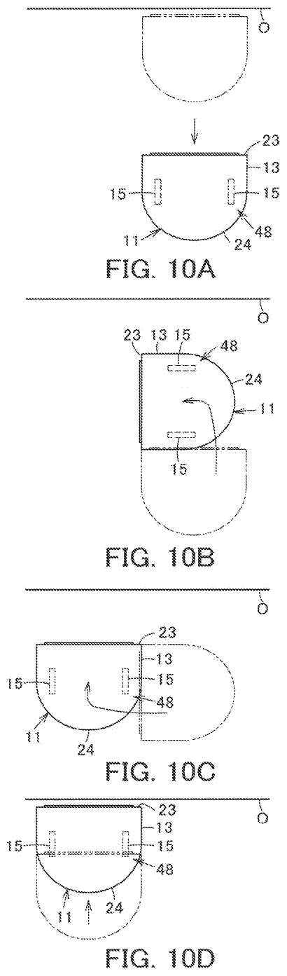

As in another example shown in FIG. 10(a) to FIG. 10(d), the travel means 48 may repeat the travel control of making the main body 13 retreat straight from the obstacle O, perform round turn to the left and further perform round turn to the right, and thereafter travel or advance toward the obstacle O.

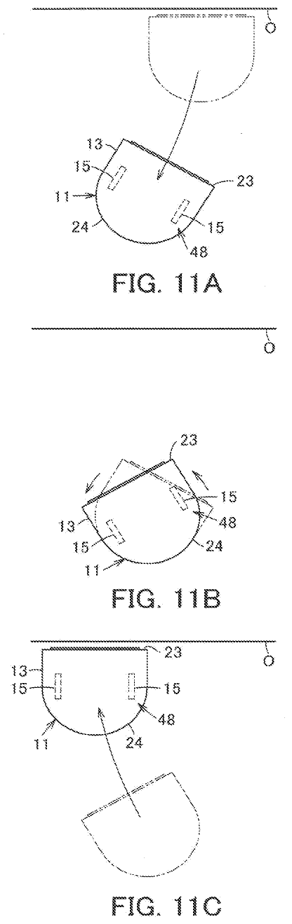

As in further another example shown in FIG. 11(a) to FIG. 11(c), the travel means 48 may repeat the travel control of making the main body 13 perform round turn to the left in the backward direction, turn left, and perform round turn to the right toward the obstacle O.

Each of FIG. 9 to FIG. 11 shows the travel control of the case of cleaning to the left direction toward the obstacle O. It is noted that, in the travel control of the case of cleaning to the right direction, the left and right directions are merely inverted from those in the above travel control. Therefore, the drawings and the descriptions thereof are omitted.

The sideways-move control performed by the travel means 48 may be, not limited only to the control shown in FIG. 9 to FIG. 11, configured in any combination such as of advancing, retreating, turning, and performing round turn to the right/left, so as to repeat the operation of temporal retreating from an obstacle, moving sideways in the width direction, and traveling to the obstacle.

The travel means 48 performs, as described above, the sideways-move control of making the main body 13 having been made to travel to the obstacle repeat the operation of temporarily retreating from the obstacle, moving sideways in the width direction, and traveling to the obstacle, whereby the cleaning means 41 is able to efficiently clean a wide area closely adjacent to the obstacle of a floor surface. In particular, the usage of the sideways-move control to an obstacle wide in the width direction such as a wall allows the cleaning means 41 to efficiently clean a wide area closely adjacent to the obstacle of a floor surface.

In the descriptions of the examples shown in FIG. 9 to FIG. 11, the obstacle O has a planar shape. While in the case where the shape of the obstacle O is a curved shape, for example, a convex curved shape or a concave curved shape in the side of the main body 13, the travel means 48 additionally performs the travel control of, likewise in the first embodiment described above, making the main body 13 having been made to travel to the obstacle O travel so that the front face part 23 of the main body 13 moves along the shape of the obstacle O in the side of the main body 13, whereby the cleaning means 41 is able to efficiently clean a wide area closely adjacent to the obstacle of a floor surface, likewise.

The cleaning means 41 in the sideways-move control cleans a floor surface at least at the position where the main body 13 has traveled to the obstacle. In the case of cleaning a floor surface at other positions, the cleaning means 41 is able to more reliably clean a floor surface in a traveling area, while in the case where the cleaning means 41 is stopped at other positions so as not to clean a floor surface, the consumption of the battery power is able to be reduced.

### Third Embodiment

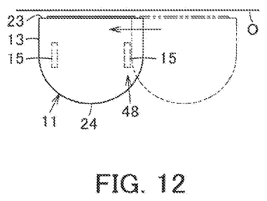

The third embodiment is described next by referring to FIG. 12. It is noted that the same configurations and actions as those of each of the embodiments described above are denoted by the same reference signs, and the descriptions thereof are omitted.

In the third embodiment, the main body 13 of the vacuum cleaner 11 is made to travel while moving sideways in the width direction along an obstacle, not made to temporarily retreat from the obstacle. In the present embodiment, a wheel or a traveling wheel movable in all directions is used as the driving wheel 15, thereby enabling to perform such control. In an example, an omni-wheel or two pairs of mecanum wheels may be used as the driving wheels 15. That is, the control of each of the driving wheels 15 allows the main body 13 to travel freely in all directions while keeping facing one direction.

Accordingly, the vacuum cleaner 11 is capable of moving sideways in the width direction along an obstacle while the front face part 23 of the main body 13 keeps facing the obstacle, and the cleaning means 41 cleans a floor surface in front of the main body 13 while the vacuum cleaner 11 moves sideways along the obstacle in such a manner. As a result, the travel control such as of temporal retreating, turning, and approaching to the obstacle is not required, and thus the cleaning means 41 is able to clean, in a shorter time, a wide area closely adjacent to the obstacle of a floor surface efficiently in a shorter time. In addition, the consumption of the battery is able to be reduced, and thus the battery lasts longer.

In the description of the example shown in FIG. 12, the shape of the obstacle O is a planar shape in the side of the main body 13. While in the case where the shape of the obstacle O in the side of the main body 13 is a convex curved shape or a concave curved shape, the travel means 48 performs the travel control of making the main body 13 move sideways in the width direction along the curved shape of the obstacle O, whereby the cleaning means 41 is able to clean an area closely adjacent to the obstacle of a floor surface, likewise.

The sideways-move control in each of the second and third embodiments described above maybe performed only in a certain condition, and in other conditions, for example, so-called along-wall traveling control may be performed, of making the main body 13 travel so that the side portion of the main body 13 moves along an obstacle. In an example, in the case where the vacuum cleaner 11 includes dust-and-dirt amount detection means, the sideways-move control may be performed only in the area where the dust-and-dirt amount detection means detects much dust and dirt, or in the case where a certain period of time or longer has elapsed from the previous cleaning to the present cleaning, the sideways-move control maybe performed. In the case where the vacuum cleaner 11 includes floor surface detection means, the sideways-move control may be performed only in the traveling area where the floor surface detection means detects the type of the floor surface as carpet. In the case where the vacuum cleaner 11 stores dust-and-dirt amount map data, the sideways-move control may be performed only in the area with much dust and dirt.

In each of the embodiments, the cleaning means 41 may not be limited to the one configured to suck dust and dirt from a floor surface into the dust-collecting unit 40, may be the one configured to scrape up dust and dirt from a floor surface to collect them into the dust-collecting unit 40, or the one configured to clean a floor surface simply by wiping and polishing a floor surface, as long as the cleaning means 41 is capable of cleaning a floor surface in front of the main body 13.

A contact sensor configured to detect contact with an object such as an obstacle may be used as the detection means 19. In this case, a plurality of units of the detection means are preferably disposed at a plurality of positions different in the width direction of the main body 13, for example, at the positions including the both side portions in the width direction of the front face part 23 of the main body 13. For example, in the case where any one of the plurality of units of the detection means 19 detects the contact with an object such as an obstacle, the travel means 48 makes the main body 13 advance until when the units of the detection means 19 disposed at the both side portions respectively are brought into contact with the object, thereby enabling to make the front face part 23 of the main body 13 face the object. Alternatively, in the case where one unit of the detection means 19 disposed on one side portion detects the contact with an object, the travel means 48 makes the other side portion of the main body 13 advance until when the unit of the detection means 19 disposed at the other side portion detects the contact with the object, thereby enabling to make the front face part 23 of the main body 13 face the object. At this time, in the case where the unit of the detection means 19 disposed at the other side portion does not detect the contact with the object even when the other side portion of the main body 13 is made to advance by a certain distance or longer, the obstacle may not have a width equal to or more than the second threshold value previously determined, that is, the obstacle may be highly possibly a bar-like obstacle having a small width, such as a pillar. In this case, the travel means 48 is able to make the main body 13 travel so as to avoid the obstacle. As described above, the use of a contact sensor as the detection means 19 also enables to realize the functions of the obstacle detection means, the width detection means, and the shape detection means. That is, a sensor serving as the detection means of the obstacle detection means, the width detection means or the shape detection means may be configured to directly detect an obstacle, the width thereof, or the shape thereof in the side of the main body 13. In this case, the configuration and the control of the vacuum cleaner 11 become simpler.

### Fourth Embodiment

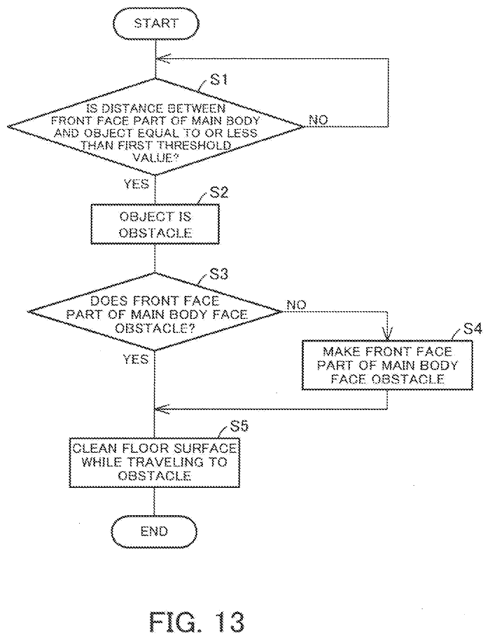

The fourth embodiment is described next by referring to FIG. 13. It is noted that the same configurations and actions as those of each of the embodiments described above are denoted by the same reference signs, and the descriptions thereof are omitted.

The fourth embodiment relates to the control of the vacuum cleaner 11 of each of the embodiments described above. The fourth embodiment generally includes a detection step in which the detection means 19 detects an obstacle in the traveling direction of the main body 13, a traveling step in which the travel means 48 makes the main body 13 travel to the obstacle so that the front face part 23 of the main body 13 faces the obstacle, on the basis of the result detected in the detection step, and a cleaning step in which the cleaning means 41 cleans a floor surface in the state where the main body 13 has been made to travel to the obstacle in the traveling step.

More specifically, in step S1, the detection means 19 determines whether or not the distance between the front face part 23 of the main body 13 and a detected object is equal to or less than the first threshold value previously determined.

In the case where, in step S1, the detection means 19 determines that the distance between the front face part 23 of the main body 13 and the detected object is not equal to or less than the first threshold value previously determined, the processing returns to step S1. In the case where, in step S1, the detection means 19 determines that the distance between the front face part 23 of the main body 13 and the detected object is equal to or less than the first threshold value previously determined, then in step S2, the detection means 19 determines that the object is an obstacle.

Next in step S3, the detection means 19 detects the distance between the front face part 23 of the main body 13 and the detected object, and determines whether or not the front face part 23 of the main body 13 faces the obstacle, on the basis of the detected distance.

In the case where, in step S3, the detection means 19 determines that the front face part 23 of the main body 13 does not face the obstacle, then in step S4, the travel means 48 makes the front face part 23 of the main body 13 face the obstacle, and thereafter the processing advances to step S5.

While in the case where, in step S3, the detection means 19 determines that the front face part 23 of the main body 13 faces the obstacle, then in step S5, the cleaning means 41 cleans a floor surface while the travel means 48 makes the main body 13 travel to the obstacle.

According to the present embodiment, as described above, since the cleaning means 41 disposed on the front portion of the main body 13 cleans a floor surface in front of the main body 13 in the state where the front face part 23 of the main body 13 having traveled to the obstacle faces the obstacle, the vacuum cleaner 11 is able to clean an area closely adjacent to the obstacle of a floor surface, by effectively utilizing the shape of the main body 13 having the front face part 23 formed in a linear shape and the cleaning means 41 disposed on the front portion thereof.

### Fifth Embodiment

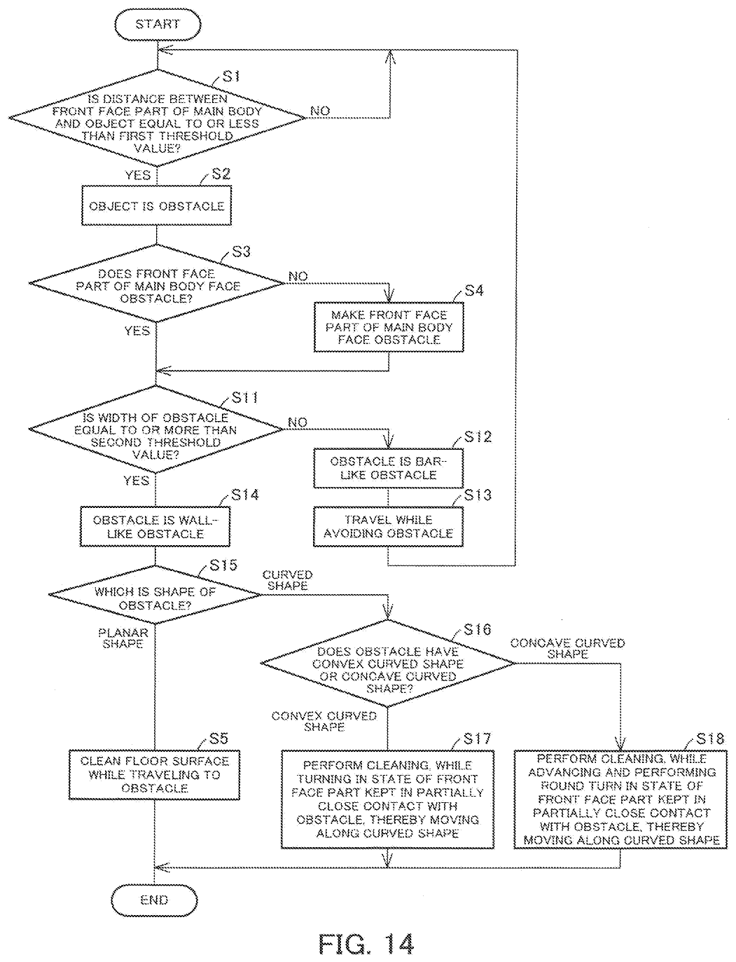

The fifth embodiment is described next by referring to FIG. 14. It is noted that the same configurations and actions as those of each of the embodiments described above are denoted by the same reference signs, and the descriptions thereof are omitted.

The fifth embodiment relates to the control of the vacuum cleaner 11 of each of the embodiments described above. In the present embodiment, the detection step of the fourth embodiment described above includes the determination on whether or not the width of the obstacle is equal to or more than the second threshold value previously determined, the determination on the shape of the obstacle in the side of the main body 13, that is, determination on whether the shape of the obstacle in the side of the main body 13 is a planar shape or a curved shape, and the determination on whether, in the case where the shape of the obstacle in the side of the main body 13 is a curved shape, the curved shape is a convex shape or a concave shape.

More specifically, in the present embodiment, in step 11 after the control in steps S1 to S4 of the fourth embodiment described above, the detection means 19 determines whether or not the width of the obstacle is equal to or more than the second threshold value previously determined in the lateral direction.

In the case where, in step S11, the detection means 19 determines that the width of the obstacle is not equal to or more than the second threshold value previously determined in the lateral direction, then in step S12, the detection means 19 determines that the obstacle is a bar-like obstacle. Thereafter in step S13, the travel means 48 makes the main body 13 travel so as to avoid the obstacle, and the processing further advances to step S1.

While in the case where, in step S11, the detection means 19 determines that the width of the obstacle is equal to or more than the second threshold value previously determined in the lateral direction, then in step S14, the detection means 19 determines that the obstacle is a wall-like obstacle. Then in step S15, the detection means 19 determines the shape of the obstacle in the side of the main body 13. Specifically, in step S15, the detection means 19 determines whether the shape of the obstacle in the side of the main body 13 is a planar shape or a curved shape.

In the case where, in step S15, the detection means 19 determines that the shape of the obstacle in the side of the main body 13 is a planar shape, the processing advances to step S5.

While in the case where, instep S15, the detection means 19 determines that the shape of the obstacle in the side of the main body 13 is a curved shape, then in step S16, the detection means 19 further determines whether the shape of the obstacle in the side of the main body 13 is a convex curved shape or a concave curved shape.

In the case where, in step S16, the detection means 19 determines that the shape of the obstacle in the side of the main body 13 is a convex curved shape, then in step S17, the cleaning means 41 cleans a floor surface, while the travel means 48 makes the main body 13 turn in the state where the front face part 23 of the main body 13 is kept in partially close contact with the obstacle and whereby the front face part 23 moves along the curved shape of the obstacle.

While in the case where, instep S16, the detection means 19 determines that the shape of the obstacle in the side of the main body 13 is a concave curved shape, then in step S18, the cleaning means 41 cleans a floor surface, while the travel means 48 makes the main body 13 advance and perform round turn in the state where the front face part 23 of the main body 13 is kept in partially close contact with the obstacle and whereby the front face part 23 moves along the curved shape of the obstacle.

As described above, the present embodiment enables to set the optimum travel control based on a shape of an obstacle, thereby enabling to improve the efficiency and accuracy in cleaning.

In each of the fourth and fifth embodiments described above, on the basis of the result detected in the detection step, the travel means 48 makes the front face part 23 of the main body 13 face the obstacle, and then makes the main body 13 travel to the obstacle along the shape of the obstacle, or may make the main body 13 further travel or temporarily stop and then travel, in the state where the front face part 23 of the main body 13 is in close contact with the obstacle.

As in the sideways-move control in the second embodiment described above, the travel means 48 may perform the control of making the main body 13 having been made to travel to the obstacle temporarily retreat from the obstacle, move sideways in the width direction, and travel to the obstacle.

As described above, the autonomous traveling type vacuum cleaner according to the present invention is capable of exhibiting the effects of removing dust and dirt more reliably in an area closely adjacent to an obstacle, according to the obstacle.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

1. An autonomous traveling type vacuum cleaner comprising:
a main body including a front face part formed in a linear shape;
a detector configured to detect an obstacle in a traveling direction of the main body;
a traveling part configured to make the front face part of the main body face the obstacle and to make the main body travel to the obstacle, on a basis of result detected by the detector; and
a cleaning unit disposed on a front portion of the main body, the cleaning unit configured to clean a cleaning-object surface in a state of the traveling part having made the main body travel to the obstacle.

2. In the autonomous traveling type vacuum cleaner according to claim 1, wherein
the traveling part makes the main body travel until when the front face part of the main body is brought into close contact with the obstacle.

3. In the autonomous traveling type vacuum cleaner according to claim 1, wherein
the traveling part makes the main body having been made to travel to the obstacle stop temporarily.

4. In the autonomous traveling type vacuum cleaner according to claim 1, wherein
the detector is a width detector configured to detect whether or not a width of the obstacle in the traveling direction of the main body is equal to or more than a threshold value previously determined in a lateral direction, and
the traveling part makes the main body travel to the obstacle when the detector detects that the width of the obstacle is equal to or more than the threshold value in the lateral direction.

5. In the autonomous traveling type vacuum cleaner according to claim 1, wherein
the detector is shape detector configured to detect whether the shape of the obstacle in a side of the main body in the traveling direction of the main body is a planar shape or a curved shape, and
when the detector detects that the shape of the obstacle in the side of the main body is a curved shape, the traveling part makes the main body travel along the shape of the obstacle.

6. In the autonomous traveling type vacuum cleaner according to claim 5, wherein
the shape detector is capable of detecting which one of a planar shape, a convex curved shape and a concave curved shape is the shape of the obstacle in the side of the main body in the traveling direction of the main body, and
when the shape detector detects the shape as a convex curved shape, the traveling part makes the main body advance in a curved manner so that the front face part of the main body moves along the shape of the obstacle in the side of the main body, and while when the shape detector detects the shape as a concave curved shape, the traveling part makes the main body turn so that the front face part of the main body moves along the shape of the obstacle in the side of the main body.

7. In the autonomous traveling type vacuum cleaner according to claim 1, wherein
the detector includes at least any two of obstacle detector configured to detect the obstacle, a width detector configured to detect a width of the obstacle, and a shape detector configured to detect a shape of the obstacle in a side of the main body.

8. In the autonomous traveling type vacuum cleaner according to claim 1, wherein
the traveling part is capable of performing sideways-move control of making the main body repeat an operation of temporarily retreating from the obstacle, moving sideways in the width direction, and traveling to the obstacle.

9. In the autonomous traveling type vacuum cleaner according to claim 1, wherein
the traveling part includes a wheel movable in all directions.

10. In the autonomous traveling type vacuum cleaner according to claim 1, wherein
the main body includes a rear face part formed in a circular arc shape.

11. A control method for an autonomous traveling type vacuum cleaner having a main body with a front face part formed in a linear shape, the autonomous traveling type vacuum cleaner being capable of traveling autonomously, the control method for the autonomous traveling type vacuum cleaner comprising:
a detection step of detecting an obstacle in a traveling direction of the main body;
a traveling step of making the front face part of the main body face the obstacle and making the main body travel to the obstacle, on a basis of a result detected in the detection step; and
a cleaning step of cleaning a cleaning-object surface in a state of the main body having been made to travel to the obstacle in the traveling step.

12. In the control method for the autonomous traveling type vacuum cleaner according to claim 11, wherein
in the traveling step, on the basis of the result detected in the detection step, the main body is made to travel until when the front face part of the main body made to face the obstacle is brought into close contact with the obstacle, and the main body is made to travel or the main body is made to temporarily stop and thereafter travel, in a state where the front face part of the main body is in close contact with the obstacle.

13. In the control method for the autonomous traveling type vacuum cleaner according to claim 11, wherein
in the traveling step, the main body having been made to travel to the obstacle is made to temporarily retreat from the obstacle, move sideways in a width direction, and travel to the obstacle.

14. In the control method for the autonomous traveling type vacuum cleaner according to claim 11, wherein
in the traveling step, the main body is made to travel along a shape of the obstacle on the basis of the result detected in the detection step.
